(19) United States
(12) Patent Application Publication
(10) Pub. No.: US 2009/0229108 A1
(43) Pub. Date: Sep. 17, 2009

(54) METHODS FOR FORMING ANTENNAS USING THERMOFORMING

(75) Inventors: Jeffrey Shamblin, San Marcos, CA (US); Torkel Danielsson, Nybro (SE); Hans Norberg, Monsteras (SE)

Correspondence Address: Coastal Patent, LLC, P.O.BOX 232340, San Diego, CA, 92193, US

(73) Assignee: Ethertronics, Inc., San Diego, CA (US)

(21) Appl. No.: 12/337,634

(22) Filed: Dec. 18, 2008

Related U.S. Application Data
(60) Provisional application No. 61/037,278, filed on Mar. 17, 2008.

(51) Int. Cl. H01P 11/00; H01Q 1/36

(52) U.S. Cl. 29/600; 343/700 R

(57) ABSTRACT

Methods for producing cost effective and reliable antennas for wireless devices are disclosed. The antennas are formed by applying a conductive layer to one or both sides of a carrier sheet. The combination of the carrier sheet and the conductive layer are then formed into one or more three-dimensional antenna structures in a thermoforming process. This -technique enables high volume production of antennas in a fast, reliable, and cost-efficient manner. The plurality of antennas formed in this fashion may then be separated by a cutting apparatus to obtain individual antennas that are ready for integration into myriad communication devices.

### CROSS-REFERENCE TO RELATED APPLICATIONS

This application claims benefit of priority of U.S. Provisional Application Ser. No. 61/037,278 titled “Methods for Forming Antennas Using Thermoforming” filed Mar. 17, 2008, the contents of which are hereby incorporated by reference.

### FIELD OF INVENTION

The present invention relates generally to the field of wireless communication. In particular, the present invention relates to antennas and methods for forming antennas for use in wireless communications.

### BACKGROUND OF THE INVENTION

With the proliferation of wireless products and services, device manufacturers are forced to aggressively pursue cost reduction opportunities in the manufacturing and assembly of wireless device components. Reduction of costs associated with wireless antennas may thus be an important factor in staying competitive. Implementation of a cost-effective antenna may become even more critical as new features and functionalities are added to wireless devices that require more sophisticated antennas.

An internal antenna for a wireless device is typically manufactured as either a stamped metal element or as a flex-circuit antenna on a plastic carrier. Both technique suffer from high cost of production. The stamped metal element and the plastic carrier both require expensive and time consuming tooling for high volume production. Furthermore, while the flex-circuit antenna may be readily fabricated using a standard etching process, this technique is typically a more expensive solution compared to a stamped metal element.

### SUMMARY OF THE INVENTION

It is the goal of the various embodiments of the present invention to provide methods of forming cost effective and reliable wireless antennas in one aspect of the invention, a method for forming an antenna comprises providing a non-conductive carrier sheet, applying a conductive layer to at least a portion of the carrier sheet, and forming one or more antennas by thermoforming the carrier sheet and the conductive layer. In one embodiment, the conductive layer is applied to one side of the carrier sheet, while in another embodiment the conductive layer is applied to both sides of the carrier sheet.

In another embodiment, the applying of the conductive layer comprises at least one of a printing, attaching, and deposition of the conductive layer in one embodiment, the printing is conducted in accordance with a stencil printer. According to another embodiment, the carrier sheet comprises a plastic sheet. In yet another embodiment, the forming produces a plurality of three-dimensional antennas that are separated into individual antenna structures with a cutting apparatus.

in another embodiment, the plurality of antennas are situated in a two dimensional array and, in another embodiment, the forming produces one or more two-dimensional antenna patterns. The antenna patterns may comprise one or more folding lines for shaping the patterns into one or more three-dimensional antenna structures. In one embodiment, one or more of the folding lines is produced using a laser cutter.

In yet another embodiment, the forming produces one or more antennas on a tape portion of a tape-on-reel package. In another embodiment, the forming further produces one or more protrusions for connecting at least one of a ground and an electrical feed associated with the antennas to a circuit board. The one or more protrusions fit into one or more depressions on the circuit board. In another embodiment, the forming further produces one or more contact bumps for connecting at least one of a ground and an electrical feed associated with the antennas to a circuit board.

In another embodiment, the one or more antennas further comprise one or more metal clips for connecting at least one of a ground and an electrical feed associated with the antennas to a circuit board. In one embodiment, the connecting is effected in accordance with one or more through holes on the circuit board while in another embodiment, the connecting is effected in accordance with one or more pads on the circuit board. In another embodiment, one or more metal springs are used for connecting at least one of a ground and an electrical feed associated with the antennas to a circuit board. In another embodiment, the thermoforming comprises vacuum forming. In yet another embodiment, the applying is carried out after thermoforming the carrier sheet.

Another aspect of the present invention relates to an antenna comprising a non-conductive portion, a conductive portion positioned on at least a portion of the non-conductive portion, and one or more protrusions in at least the conductive portion for connecting at least one of a ground and an electrical feed associated with the antenna to a circuit board. The antenna may be formed by applying a conductive layer to a non-conductive carrier sheet and thermoforming the carrier sheet and conductive layer. The antenna may also be formed by thermoforming a non-conductive carrier sheet and applying a conductive layer to the thermoformed carrier sheet.

Those skilled in the art will appreciate that various embodiments discussed above, or parts thereof, may be combined in a variety of ways to create further embodiments that are encompassed by the present invention.

### BRIEF DESCRIPTION OF THE DRAWINGS

FIG. 1 illustrates an exemplary flow diagram in accordance with an example embodiment of the present invention;

FIG. 2 illustrates an exemplary flow diagram in accordance with an embodiment of the present invention;

FIG. 3 illustrates an antenna in accordance with an exemplary embodiment of the present invention;

FIG. 4 illustrates an exemplary antenna in accordance with an embodiment of the present invention;

FIG. 5(a) illustrates a tape strip corresponding to a tape-and-reel system;

FIG. 5(b) illustrates a plurality of antennas in accordance with an exemplary embodiment of the present invention;

FIG. 6 illustrates an antenna in accordance with an exemplary embodiment of the present invention;

FIG. 7 illustrates an antenna in accordance with an exemplary embodiment of the present invention;

FIG. 8 illustrates an antenna in accordance with an exemplary embodiment of the present invention;

FIG. 9 illustrates an antenna in accordance with an exemplary embodiment of the present invention; and

FIG. 10 illustrates an antenna in accordance with an exemplary embodiment of the present invention.

### DETAILED DESCRIPTION OF THE PREFERRED EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

The antennas and methods described in accordance with embodiments of the present invention reduce the number of components in a wireless antenna to a as few as a single component, and thus significantly reduce the complexity and costs associated with antenna fabrication. Embodiments of the invention achieve this goal by manufacturing cost-effective antenna structures using a thermoforming process. Thermoforming may refer to the process of forming a thermoplastic sheet into a three-dimensional shape by clamping the sheet in a frame, heating it to render it soft and pliable, then applying differential pressure to make the sheet conform to the shape of a mold or die positioned below the frame. When the pressure is applied entirely by vacuum, the process is called ‘vacuum forming.’

In accordance with the various embodiments of the present invention, prior to vacuum forming, a conductive antenna pattern may be printed, deposited, or placed (hereinafter, collectively referred to as ‘applied’) on a plastic sheet or other nonconductive carrier material. The conductive antenna pattern may be applied to one or both sides of the plastic carrier. In some applications, however, it may be advantageous to use the plastic sheet as a protective layer by applying the antenna pattern to the bottom of the plastic carrier. This configuration, which may also provide an enhanced cosmetic appearance, can be used to implement an integrated contact point between the antenna terminals and the circuit board of the wireless device. Once the conductive material is applied to the plastic carrier, the vacuum forming process, or other processes for providing a pressure differentiated forming, creates one or more low cost antennas with an integrated plastic carrier. A laser or other cutting mechanism may be used to subsequently cut out individual finished antenna structures that are now ready to be integrated into various communication devices.

The conductive pattern may be applied using a variety of techniques, including, but not limited to, printing conductive (e.g., silver) inks, placing or attaching copper or aluminum sheets, or depositing copper or other conductive materials on the plastic sheet using electro-deposition or similar techniques. The conductive material may be any one of silver, copper, aluminum, gold, or other conductive elements or composites. In one embodiment, the antenna pattern may be cut, punched, or etched onto the conductive material prior to it application to the plastic sheet. It should also be noted that the choice of non-conductive material is not limited to plastic, and it may comprise any material that can be formed by the thermoforming process.

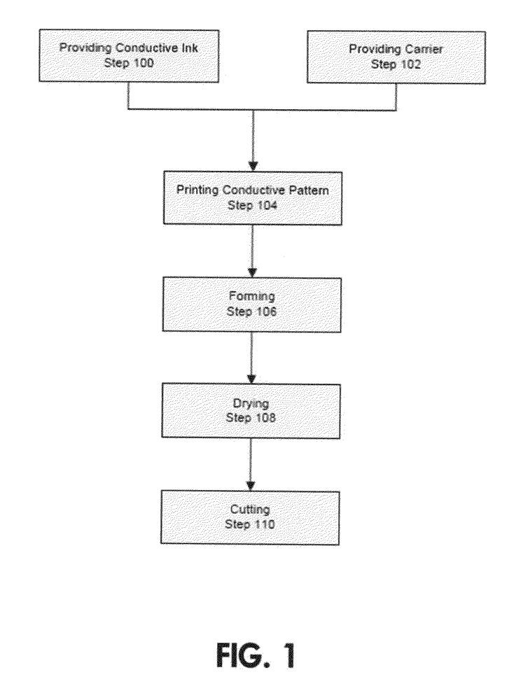

FIG. 1 illustrates a flow diagram of an antenna forming process in accordance with an exemplary embodiment of the present invention. This exemplary embodiment uses a stencil printer to print the conductive antenna pattern on a non-conductive carrier. Step 100 includes providing the conductive ink for printing. Step 102, which may be carried out at the same time as Step 100, includes providing the carrier, which may comprise a non-conductive material such as plastic. However, as noted earlier, the carrier may include any suitable material other than plastic that can be utilized in the thermoforming process. In Step 104, printing of the conductive antenna pattern on the carrier takes place. The printing process may be carried out using, for example, a Surface Mount Technology (SMT) stencil printer that is used in the manufacturing of electronic circuit boards. Alternatively, screening techniques and apparatus may be used for printing the conductive pattern on the carrier. Furthermore, depending on the antenna design specifications and preferences, the conductive pattern may be printed on one or both sides of the carrier sheet.

Referring again to FIG. 1, Step 106 includes forming of the antenna by utilizing the thermoforming process. This step may be carried out using a vacuum forming apparatus, such as those utilized in, for example, the packaging industry. For example, an FDH Series vacuum forming machine, manufactured by Formech Inc., may be used. Of course, other manners of providing the necessary pressure differential may also be used and are contemplated within the scope of the present invention. In Step 108, the thermoformed antennas are: dried. A reflow oven or other drying system is used to cure the silver ink. Finally, in Step 110, the thermoformed antennas are cut into individual antenna assemblies that can be incorporated into wireless devices or other communication systems. The cutting (Step 110) may be carried out using a laser cutter or other cutting apparatus. In one example embodiment, the plurality of thermoformed antennas may reside in a two-dimensional array and are subsequently separated or cut out to form the individual antennas.

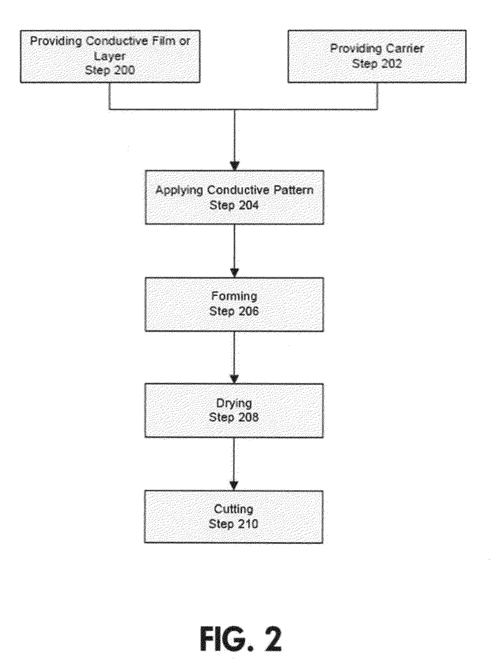

FIG. 2 illustrates a flow diagram of an antenna forming process in accordance with an another embodiment of the present invention. Step 200 includes providing a conductive film or layer for producing the antenna pattern. Step 202, which may be carried out at the:same time as Step 200, includes providing the carrier, which is comprised of a suitable non-conductive material such as plastic. In Step 204, the conductive pattern is applied to the non-conductive carrier using techniques such as printing, deposition, or attachment. Steps 206 through 210 are similar to those described in connection with Steps 106 to 110 of FIG. 1. More specifically, in Step 206, the antennas are formed using thermoforming techniques. In Step 208, the antennas are dried, and in Step 210, the antennas are cut into separate antenna assemblies that can be deployed in wireless or other communication systems. While the embodiments of the present invention, as illustrated in FIGS. 1 and 2, describe several exemplary steps for forming the antennas of the present invention, it is understood that the scope of the antenna forming process in accordance with the embodiments of the present invention encompasses variations to the above-described antenna forming processes. For example, one or more steps of FIGS. 1 and 2 may be removed, combined, or carried out in a different order. For example, in another embodiment, a carrier sheet may be thermoformed prior to the application of a conductive layer. In accordance with this exemplary embodiment, the conductive layer, which may be applied after the thermoforming process, can be a metalized film with an adhesive layer for attachment to the formed carrier.

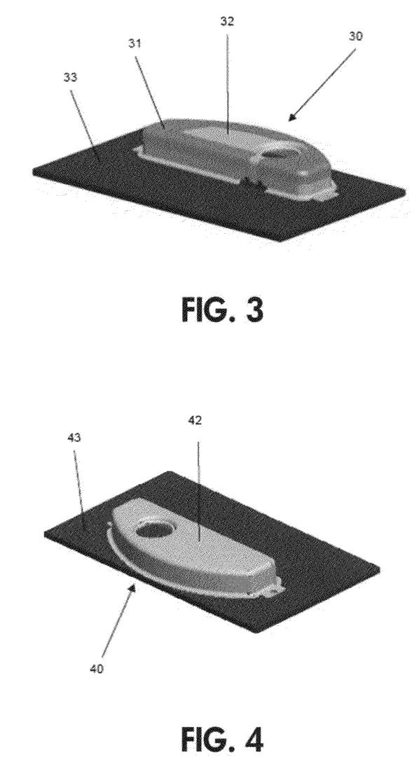

FIG. 3 shows an antenna 30 that may be formed in accordance with an exemplary embodiment of the present invention. The exemplary antenna 30 of FIG. 3 comprises an external conductive pattern 31, and is formed by applying the conductive material to the top of the plastic carrier 32 prior to thermoforming the three-dimensional antenna structure 30. The antenna 30 may be placed on a PCB 33 or otherwise integrated into a communication device. FIG. 4 illustrates another exemplary antenna 40 in accordance with an embodiment of the present invention. This exemplary antenna 40 comprises an internal conductive pattern (not visible in FIG. 4), and may be formed by applying the conductive pattern to the bottom side of the plastic carrier 42 prior to thermoforming the three-dimensional antenna structure. The antenna 40 may be placed on a PCB 43 or otherwise integrated into a communication device. The internal conductive pattern may also be used to implement an integrated contact point between the ground and/or electrical feeds associated with the antenna 40 and the appropriate connections on the PCB 43.

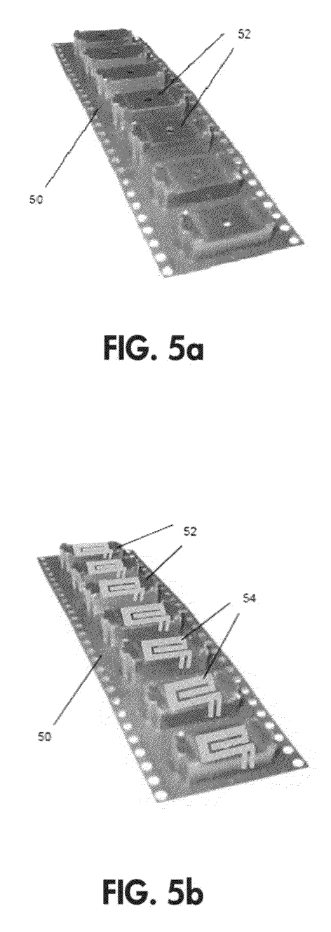

In another embodiment of the present invention, tape-and-reel packaging techniques may be adapted to enable manufacturing of low cost integrated antennas. Tape-and-reel packaging comprises a carrier ‘tape’ with formed cavities for holding the SMD (surface mount device) components. FIG. 5(a) illustrates an exemplary tape 50 with a plurality of formed cavities 52. A tape-and-reel package may accommodate up to several hundreds of thousands components that may be used by pick-and-place machines for automated assembly of electronic circuit boards, for example. In accordance with an example embodiment of the present invention, the plastic ‘tape’ 50 may be metalized by applying one or more antenna conductive patterns on the ‘tape’ strip prior to forming the cavities 52. Once the cavities are formed, individual antennas may be cut out from the strip, and used for integration into communication devices. FIG. 5(b) illustrates a series of exemplary antennas that are formed, in accordance with an exemplary embodiment of the present invention, by applying one or more conductive antenna patterns 54 on a tape strip 50, prior to forming of the cavities 52. It should be noted that while, in FIG. 5(b), only the conductive antenna patterns 54 on top side of cavities 52 are visible, antenna patterns may exist on either or both sides of the formed cavities. The antennas formed in this fashion are arranged in a single column that may be placed onto a reel and cut into individual antennas at a later time. The placement of the conductive patterns on the plastic tape carrier may be accomplished using any one of the techniques described in connection with Step 104 of FIG. 1, or Step 204 of FIG. 2.

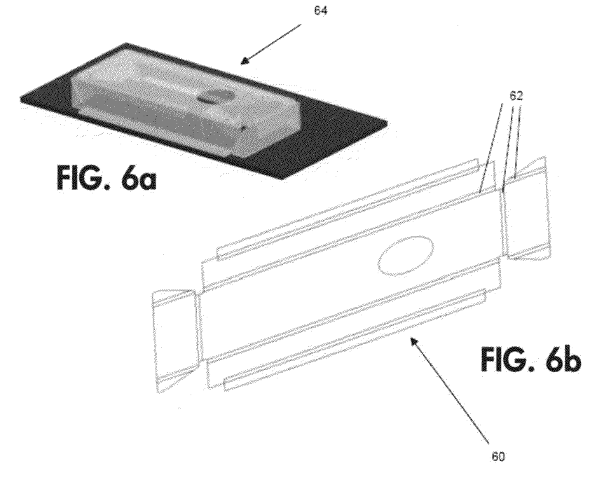

In accordance with another embodiment of the present invention, the conductive material may be applied to one or both sides of a carrier to form a two-dimensional sheet with a plurality of antenna patterns. The two-dimensional antenna patterns may further be folded along predetermined locations to form the final three-dimensional antenna structures. This process may be facilitated by using a cutting apparatus, such as a laser cutter, to create ‘folding’ lines on the two-dimensional antenna sheets. Alternatively, or additionally, the thermoforming process can be used to form the folding lines. The individual two-dimensional antenna structures may then be folded along these lines at any time prior to the integration of the antennas into the communication devices. FIGS. 6a-b illustrate an exemplary two-dimensional antenna 60 that may be folded along a plurality of folding lines 62 to form a three-dimensional antenna structure 64 in accordance to an exemplary embodiment of the present invention.

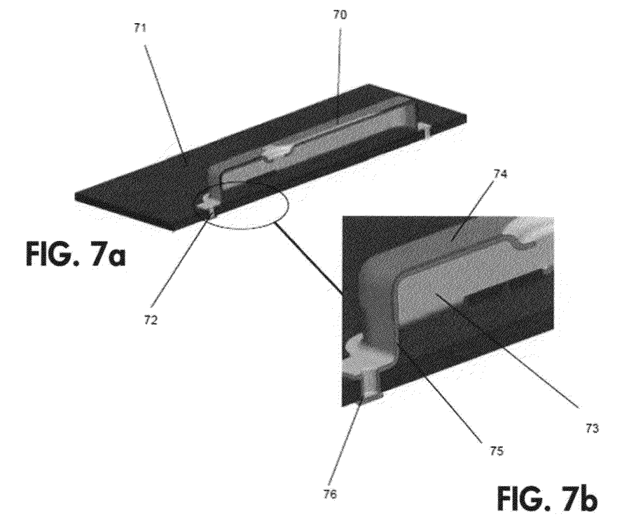

FIGS. 7a-b illustrate another antenna in accordance with an exemplary embodiment of the present invention. Antenna 70 is placed (or attached) to a printed circuit board (PCB) 71 or another intended device. FIGS. 7a-b show a cross sectional view of a thermo-formed antenna 70 that comprises a thermoformed cylindrically shaped protrusion 72 for providing mechanical and/or electrical contact with a PCB 71. The cylindrical protrusion 72, or other custom-shaped feature, may be designed to fit into a cavity or depression on the circuit board. If the cavity on the circuit board is plated, then the cylindrically shaped protrusion on the antenna with conductive coating will provide electrical continuity between the antenna and circuit board. In the exemplary embodiment of FIGS. 7a-b, heat stacking, a process which forms a bond by partially melting a protrusion of one plastic part to provide a locking fit to another component, is used. The location that is heat stacked to the PCB may be isolated from the electrical connections for the antenna, or may be used to feed the antenna and/or provide a ground connection. In the exemplary embodiment of FIGS. 7a-b, the antenna comprises both an external conductive pattern 74 (that is applied to the top of the non-conductive carrier 73) and an internal conductive pattern 75 (that is applied to the bottom of the non-conductive carrier 73). In one exemplary embodiment, the antenna feed and/or ground connection may be provided through the conductive layer that surrounds the cylindrical protrusion 76.

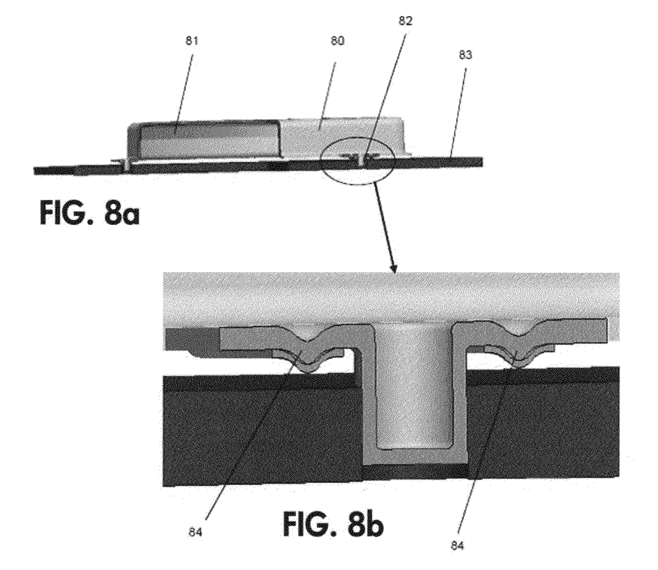

In accordance with another embodiment of the present invention, integrated contact bumps are implemented for providing electrical connection between the feed and/or ground point of the thermoformed antenna and the circuit board of the communication system. FIGS. 8a-b, in accordance with an exemplary embodiment of the present invention, illustrate a PCB 83, and a thermoformed antenna 80 that comprises an internal conductive pattern 81, one or more heat stacking pins 82, and one or more integrated contact bumps 84. The one or more integrated bumps 84 are situated close to one or more heat stacking pins 82, and comprise plastic bumps that are covered by conductive material and collectively formed in a thermoforming process. The bumps act as ‘springs,’ and are situated at desired locations to allow positive contact pressure to apply between the feed and ground points of the antenna and the appropriate locations on the PCB 83. The contact force is a function of the plastic wall thickness and the dimensions of the bump.

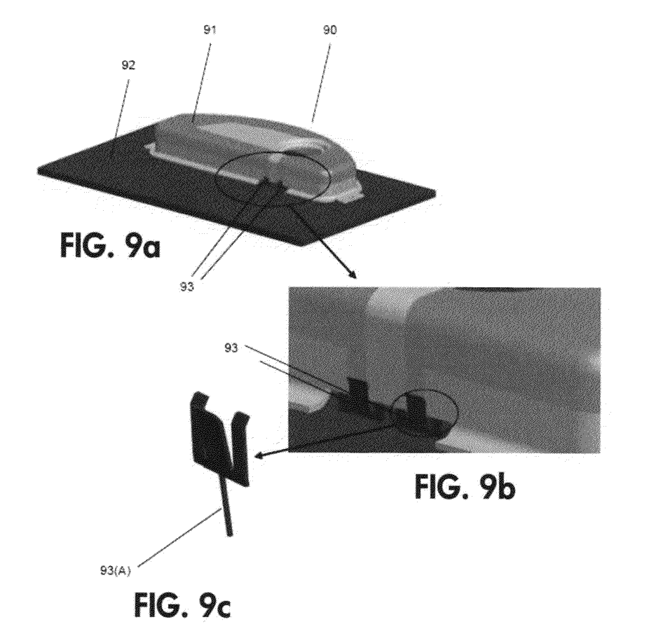

In accordance with another embodiment of the present invention, metalclips are used to provide a connection between the antenna feed and/or ground locations of the thermoformed antenna and the circuit board. FIGS. 9a-c illustrate an exemplary embodiment comprising a thermoformed antenna 90 that is placed on a PCB 92. The exemplary antenna 90 has an external conductive pattern 91 and one or more metallic contact clips 93 that connect the antenna feed and/or ground to the PCB 92. The contact force is determined by the dimensions of the clip and the thickness of the antenna walls. The exemplary contact clip of FIG. 9 comprises a stem 93A that is designed to fit into a plated through hole of the PCB 92. In an alternate embodiment, a contact clip with no stem (or a smaller stem) may be utilized that allows electrical contact between a conductive pad on the PCB 92 and the contact clip 93. Soldering or a conductive epoxy can be used to maintain contact between the contact clip and pad on the circuit board.

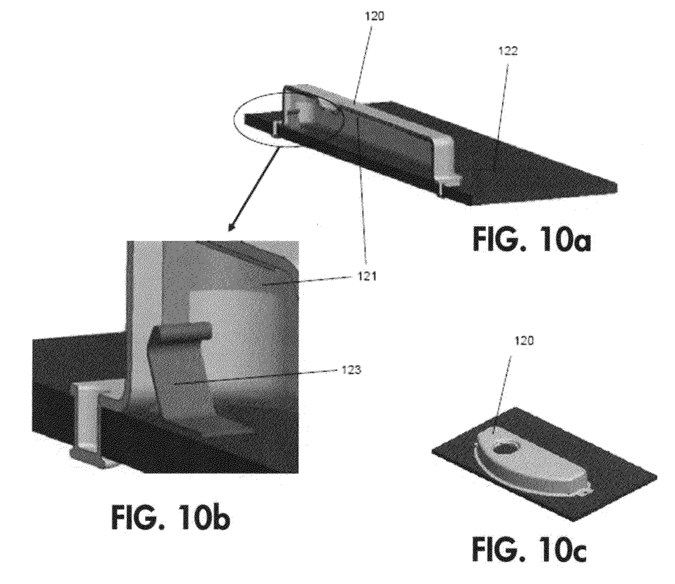

In accordance with another embodiment of the present invention, electrical contact between the feed and/or ground locations of an antenna with a circuit board may be effected using a contact spring. FIGS. 10a-c illustrate an exemplary embodiment comprising a thermoformed antenna 120 that is connected to a PCB 122. The exemplary antenna 120 has an internal conductive pattern 121 and one or more contact springs 123 that connect the feed and/ground on the internal antenna pattern to the PCB 122.

While particular embodiments of the present invention have been disclosed, it is to be understood that various modifications and combinations are possible and are contemplated within the true spirit and scope of the appended claims. There is no intention, therefore, of limitations to the exact abstract and disclosure herein presented.

What is claimed is:

1. A method for forming an antenna, comprising;
providing a non-conductive carrier sheet;
applying a conductive layer to at least a portion of said carrier sheet; and
forming one or mote antennas by thermoforming said carrier sheet and said conductive layer.

2. The method of claim 1, wherein said conductive layer is applied to one side of said carrier sheet.

3. The method of claim 1, wherein said conductive layer is applied to both sides of said carrier sheet.

4. The method of claim 1, wherein said applying comprises at least one of a printing, attaching, and deposition of said conductive layer.

5. The method of claim 4, wherein said printing is conducted in accordance with a stencil printer.

6. The method of claim 1, wherein said carrier sheet comprises a plastic sheet.

7. The method of claim 1, wherein said forming produces a plurality of three-dimensional antennas that are separated into individual antenna structures with a cutting apparatus.

8. The method of claim 7, wherein said plurality of antennas are situated in a two-dimensional array.

9. The method of claim 1, wherein said forming produces one or more two-dimensional antenna patterns.

10. The method of claim 9, wherein said antenna patterns comprise one or more folding lines for shaping said patterns into one or more three-dimensional antenna structures.

11. The method of claim 10, wherein one or more of said folding lines is produced using a laser cutter.

12. The method of claim 1, wherein said forming produces one or more antennas on a tape portion of a tape-on-reel package.

13. The method of claim 1, wherein said forming further produces one or more protrusions for connecting at least one of a ground and an electrical feed associated with said antennas to a circuit board.

14. The method of claim 13, wherein said one or more protrusions fit into one or more depressions on said circuit board.

15. The method of claim 1, wherein said forming further produces one or more contact bumps for connecting at least one of a ground and an electrical feed associated with said antennas to a circuit board.

16. The method of claim 1, wherein said one or more antennas further comprise one or more metal clips for connecting at least one of a ground and an electrical feed associated with said antennas to a circuit board.

17. The method of claim 16, wherein said connecting is effected in accordance with one or more through holes on said circuit board.

18. The method of claim 16, wherein said connecting is effected in accordance with one or more pads on said circuit board.

19. The method of claim 1, wherein one or more metal springs are used for connecting at least one of a ground and an electrical feed associated with said antennas to a circuit board.

20. The method of claim 1, wherein said thermoforming comprises vacuum forming.

21. The method of claim 1, wherein said applying is carried out after thermoforming said carrier sheet.

22. An antenna, comprising;
a non-conductive portion;
a conductive portion positioned on at least a portion of said nonconductive portion; and
one or more protrusions in at least said conductive portion for connecting at least one of a ground and an electrical feed associated with said antenna to a circuit board.

23. The antenna of claim 22, wherein said antenna is formed by applying a conductive layer to a nonconductive carrier sheet and thermoforming said carrier sheet and said conductive layer.

24. The antenna of claim 23, wherein said thermoforming comprises vacuum forming.

25. The antenna of claim 22, wherein said conductive portion resides on one side of said non-conductive portion.

26. The antenna of claim 22, wherein said conductive portion resides on both sides of said non-conductive portion.

27. The antenna of claim 23, wherein said applying comprises at least one of a printing, attaching, and deposition of said conductive layer.

28. The antenna of claim 27, wherein said printing is conducted in accordance with a stencil printer.

29. The antenna of claim 22, wherein said non-conductive portion comprises a plastic portion.

30. The antenna of claim 23, wherein said thermoforming produces a plurality of three-dimensional antennas that are separated into individual antenna structures with a cutting apparatus.

31. The antenna of claim 30, wherein said plurality of antennas are situated in a two-dimensional array.

32. The antenna of claim 22, wherein said one or more protrusions fit into one or more depressions on said circuit board.

33. The antenna of claim 22, further comprising one or more contact bumps for connecting at least one of a ground and an electrical feed associated with said antennas to a circuit board.

34. The antenna of claim 22, further comprising one or more metal clips for connecting at least one of a ground and an electrical feed associated with said antennas to a circuit board.

35. The antenna of claim 34, wherein said connecting is effected in accordance with one or more through holes on said circuit board.

36. The antenna of claim 34, wherein said connecting is effected in accordance with one or more pads on said circuit board.

37. The antenna of claim 22, further comprising one or more metal springs for connecting at least one of a ground and an electrical feed associated with said antennas to a circuit board.

38. The antenna of claim 22, wherein said antennas are formed on the tape portion of a tape-and-reel package.

39. The antenna of claim 22, wherein said antenna is formed as a two-dimensional conductive pattern on a non-conductive carrier sheet that further comprises one or more folding lines for shaping said two-dimensional pattern into a three-dimensional antenna structure.

40. The antenna of claim 22, wherein said antenna is formed by thermoforming a non-conductive carrier sheet and applying a conductive layer to the thermoformed carrier sheet.
